(19) United States
(12) Patent Application Publication
(10) Pub. No.: US 2026/0089693 A1
(43) Pub. Date: Mar. 26, 2026

(54) METHOD AND DEVICE FOR DETERMINING BANDWIDTH PART, METHOD AND DEVICE FOR CONFIGURING BANDWIDTH PART, MEDIUM, AND PROGRAM PRODUCT

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/111,166

(22) PCT Filed: Sep. 13, 2022
(86) PCT No.: PCT/CN2022/118563

§ 371 Date: Mar. 12, 2025

(51) Int. Cl. H04W 72/044; H04L 5/00

(52) U.S. Cl. CPC H04W 72/044; H04L 5/0005

(57) ABSTRACT

A bandwidth part (BWP) determining method, including: determining the BWP of a user equipment, where the BWP includes frequency domain resources of M time-frequency resources, and M is an integer greater than 1.

### CROSS-REFERENCE

The present application is a U.S. National Stage of International Application No. PCT/CN2022/118563, filed on Sep. 13, 2022, the contents of which are incorporated herein by reference in their entirety for all purposes.

### BACKGROUND OF THE INVENTION

In the work item description (WID) of release 18 (Rel-18) of the 5th generation mobile communication technology (5G), the project of new radio (NR) supporting a bandwidth less than 5 MHz was approved.

### SUMMARY OF THE INVENTION

The present disclosure relates to the field of communication, and particularly relates to a method and device for determining a bandwidth part (BWP), a method and device for configuring the BWP, a medium, and a program product.

A method and device for determining a bandwidth part (BWP), a method and device for configuring the BWP, a medium, and a program product are provided in embodiments of the present disclosure. The technical solution is as follows.

A method for determining the BWP is provided in an aspect of the embodiments of the present disclosure. The method is performed by a user equipment. The method includes:
determining the BWP of the user equipment. The BWP includes frequency domain resources of M time-frequency resources. M is an integer greater than 1.

A method for determining the BWP is provided in another aspect of the embodiments of the present disclosure. The method is performed by the user equipment. The method includes:
determining a BWP of the user equipment based on first information. The first information is related to a synchronization signal block.

A method for configuring the BWP is provided in another aspect of the embodiments of the present disclosure. The method is performed by a network device. The method includes:
configuring the BWP for the user equipment. The BWP includes frequency domain resources of M time-frequency resources. M is an integer greater than 1.

It should be understood that the above general description and the following detailed description are merely illustrative and explanatory, instead of limiting the present disclosure.

### BRIEF DESCRIPTION OF DRAWINGS

To describe technical solutions in embodiments of the present disclosure more clearly, the accompanying drawings required for describing the embodiments will be briefly introduced below. Obviously, the accompanying drawings in the following description show merely some embodiments of the present disclosure, and those of ordinary skill in the art can also derive other accompanying drawings from these accompanying drawings without creative efforts.

FIG. 1 is a block diagram of a communication system according to an example;

FIG. 2 is a flowchart of a method for determining a bandwidth part (BWP) according to an example;

FIG. 3 is a schematic diagram of frequency domain concatenation according to an example;

FIG. 4 is a flowchart of a method for determining a BWP according to another example;

FIG. 5 is a schematic diagram of frequency domain concatenation according to another example;

FIG. 6 is a flowchart of a method for determining the BWP according to another example;

FIG. 7 is a flowchart of a method for determining the BWP according to another example;

FIG. 8 is a schematic diagram of determining the BWP according to another example;

FIG. 9 is a schematic diagram of determining the BWP according to another example;

FIG. 10 is a schematic diagram of determining the BWP according to another example;

FIG. 11 is a schematic diagram of determining the BWP according to another example;

FIG. 12 is a schematic diagram of determining the BWP according to another example;

FIG. 13 is a schematic diagram of determining the BWP according to another example;

FIG. 14 is a schematic diagram of determining the BWP according to another example;

FIG. 15 is a schematic diagram of determining the BWP according to another example;

FIG. 16 is a flowchart of a method for determining a first bandwidth according to an example;

FIG. 17 is a schematic diagram of determining the first bandwidth according to an example;

FIG. 18 is a block diagram of a device for determining the BWP according to an example;

FIG. 19 is a block diagram of a device for determining the BWP according to another example;

FIG. 20 is a block diagram of a device for determining the BWP according to another example;

FIG. 21 is a schematic structural diagram of a terminal according to an example; and

FIG. 22 is a schematic structural diagram of an access network device according to an example.

### DETAILED DESCRIPTION OF THE INVENTION

Examples will be described in detail here and shown in the accompanying drawings illustratively. When the following description involves the accompanying drawings, unless otherwise specified, an identical number in different accompanying drawings denotes identical or similar elements. Implementations described in the following examples do not denote all implementations consistent with the present disclosure. On the contrary, the implementations are merely instances of a device and a method consistent with some aspects of the present disclosure as detailed in the appended claims.

In work item description (WID) of release 18 (Rel-18) of the 5th generation mobile communication technology (5G), the project of new radio (NR) supporting a bandwidth less than 5 MHz is approved. The bandwidth less than 5 MHz is preferably 3 MHz or 3.6 MHz. If computation is performed with a sub-carrier space (SCS) as 15 kHz, a number of available resource blocks (RBs) in an entire system bandwidth of a communication system does not exceed 20, while frequency domain resources occupied by a synchronization signal block (SSB) accessed initially are 20 RBs. On the premise that time-frequency domain mapping of the SSB is not optimized, system frequency domain resources are insufficient, and the SSB may exceed the system bandwidth. At present, bandwidth resources occupied by a control resource set 0 (CORESET0) are at least 24 RBs, which may also cause the CORESET0 to exceed the system bandwidth.

In addition, an initial bandwidth is defined as at least 5 MHz, which also faces an identical problem. For instance, in some scenarios where a downlink bandwidth is punctured, a signal or a channel cannot be mapped due to bandwidth reduction. For instance, in subband full duplex, in order to reduce feedback delay, a downlink resource or a flexible resource may be borrowed by uplink transmission. In this case, the downlink bandwidth is punctured, such that the downlink bandwidth is divided, and a remaining bandwidth may not satisfy resource mapping of the signal or the channel.

Alternatively, there are also scenarios where usage is limited to a low bandwidth for energy-saving needs. In this case, although various downlink signals or downlink channels may be mapped completely, the bandwidth resources may only be limited to narrow bands, such that abnormal transmission of various downlink signals or downlink channels may be caused.

In view of the above technical problems, a solution is provided as follows: frequency domain compression is performed on an original channel or signal, each with a great bandwidth, so that the channel or the signal may be accommodated within a system bandwidth less than 5 MHz. However, the solution obviously needs to modify the SSB, the CORESET0, an initial bandwidth part (BWP), etc. to a great extent.

Thus, another solution is provided in the present disclosure as follows: frequency domain resources located in different time domains are concatenated to make a concatenated bandwidth satisfy mapping of the channel or the signal. In this way, technical problems of how to map channels or signals with a great bandwidth and how to satisfy a scheduling requirement of the great bandwidth in a scenario with a limited bandwidth are solved.

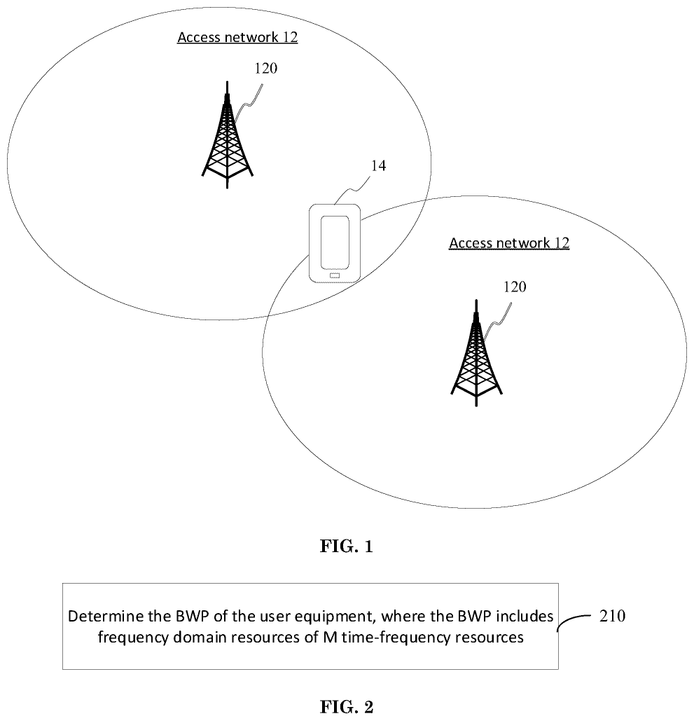

FIG. 1 shows a block diagram of a communication system provided in an example of the present disclosure. The communication system may include: an access network 12 and a user equipment 14.

The access network 12 includes several network devices 120. The network devices (also referred to as access network devices) 120 may be base stations. The base stations are devices that are deployed in an access network to provide a wireless communication function for the user equipment (referred to as a “terminal” for short) 14. The base stations may include various forms of macro base stations, micro base stations, relay stations, access points, etc. In systems using different wireless access technologies, devices with a base station function may have different names. For instance, in a long term evolution (LTE) system, the device is referred to as eNodeB or eNB. In a 5th-generation (5G) new radio (NR) system, the device is referred to as gNodeB or gNB. With evolution of communication technologies, such description of the “base station” may be changed. For convenience of embodiments of the present disclosure, the device providing the wireless communication function for the user equipment 14 are collectively referred to as network devices.

The user equipment 14 may include various handheld devices, vehicle-mounted devices, wearable devices or computing devices with a wireless communication function, or other processing devices connected to wireless modems, and various forms of user equipment, mobile stations (MSs), terminal devices, etc. For convenience of description, the above-mentioned devices are collectively referred to as user equipment. The network device 120 is in communication with the user equipment 14 through some radio technology, such as a user-to-user (Uu) interface.

For instance, two communication scenarios are provided between the network device 120 and the user equipment 14, and include: an uplink communication scenario and a downlink communication scenario. Uplink communication is to send the signal to the network device 120. Downlink communication is to send the signal to the user equipment 14.

The technical solution of the embodiments of the present disclosure may be applied to various communication systems, such as a global system of mobile communication (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of the NR system, an LTE-based access to unlicensed spectrum (LTE-U) system, an NR-U system, a universal mobile telecommunication system (UMTS), a worldwide interoperability for microwave access (WiMAX) communication system, a wireless local area networks (WLAN), wireless fidelity (WiFi), a next generation communication system, or other communication systems.

Generally, a number of connections supported by a traditional communication system is limited and is easy to implement. However, with development of communication technologies, a mobile communication system may not only support traditional communication, but also support, for instance, device to device (D2D) communication, machine to machine (M2M) communication, machine type communication (MTC), vehicle to vehicle (V2V) communication, a vehicle to everything (V2X) system, etc. The embodiments of the present disclosure may alternatively be applied to the communication systems.

FIG. 2 shows a flowchart of a method for determining the BWP provided in an example of the present disclosure. The method is applied to the user equipment of the communication system shown in FIG. 1. The method includes the following step.

Step 210, the BWP of the user equipment is determined, where the BWP includes frequency domain resources of M time-frequency resources.

M is an integer greater than 1. The BWP includes the frequency domain resources of the M time-frequency resources. Alternatively, the BWP includes frequency domain bandwidths of the M time-frequency resources. Alternatively, the BWP includes the sum of the frequency domain resources of the M time-frequency resources. Alternatively, the BWP includes the sum of frequency domain bandwidths of the M time-frequency resources.

Alternatively, time domain resource positions of the M time-frequency resources correspond to at least two time periods.

For instance, time domain resources of the M time-frequency resources correspond to M time periods. In the M time-frequency resources, a time domain resource of each time-frequency resource is different from time domain resources of other (M−1) time-frequency resources. Alternatively, time domain resources of the M time-frequency resources correspond to M′ time periods. M′<M, and M′ is an integer greater than 1. In the M time-frequency resources, at least two time-frequency resources have identical time domain resources.

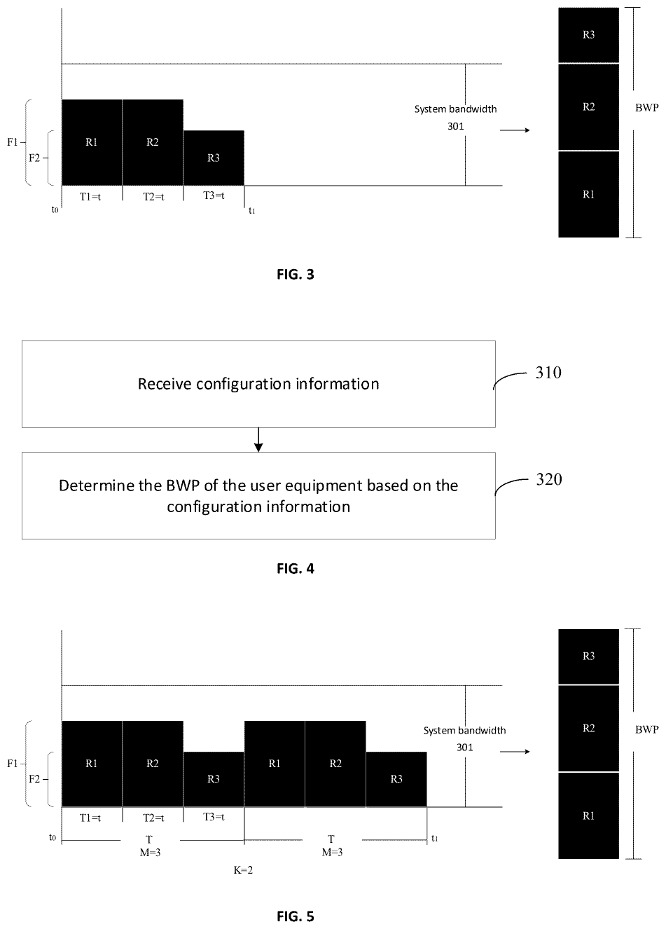

Alternatively, durations of the at least two time periods are identical. For instance, as shown in FIG. 3, 3 time-frequency resources are R1, R2 and R3 respectively. R1 corresponds to a time period T1, R2 corresponds to a time period T2, and R3 corresponds to a time period T3. T1, T2 and T3 all have duration t, and t is a positive number. Additionally, system bandwidth 301 is shown in FIG. 3.

Alternatively, frequency domain resource positions of the M time-frequency resources are completely overlapped; or, frequency domain resource positions of the M time-frequency resources are partially overlapped. For instance, as shown in FIG. 3, frequency domain resource positions of R1 and R2 are F1, and are completely overlapped. A frequency domain resource position of R3 is F2, a frequency domain resource position of R3 is partially overlapped with the frequency domain resource positions of R2 and R1, and R3 is overlapped with R2 and R1 at a frequency domain resource position F2.

For instance, the M time-frequency resources are arranged in a sequential order in a time domain, and the BWP of the user equipment is obtained. A high-frequency edge of an i-th time-frequency resource in the M time-frequency resources is connected to a low-frequency edge of an (i+1)-th time-frequency resource, and i is a positive integer less than M. For instance, a high-frequency edge of a first time-frequency resource is connected to a low-frequency edge of a second time-frequency resource, a high-frequency edge of the second time-frequency resource is connected to a low-frequency edge of a third time-frequency resource, and so on. A frequency domain resource obtained through connection is determined as the BWP of the user equipment. As shown in FIG. 2, a high-frequency edge of R1 is connected to a low-frequency edge of R2, and a high-frequency edge of R2 is connected to a low-frequency edge of R3, such that the BWP after R1, R2 and R3 are connected is obtained.

For instance, in a case that frequency domain concatenation is applied to an uplink bandwidth, resources corresponding to all slots are uplink resources. In a case that the frequency domain concatenation is applied to a downlink bandwidth, resources corresponding to all slots are downlink resources.

In conclusion, according to the method for determining the BWP provided in the embodiment, the user equipment uses the frequency domain resources of the M time-frequency resources as its own BWP. In this way, a greater bandwidth may be obtained by scheduling frequency domain resources of a plurality of time-frequency resources. For instance, in a case that a bandwidth of a scheduling requirement between the user equipment and the network device is greater than the system bandwidth of the communication system, a bandwidth satisfying the scheduling requirement may be obtained by scheduling the frequency domain resources of the plurality of time-frequency resources as the BWP.

In the embodiment shown in FIG. 2, the BWP may be determined based on configuration information sent by a network device to the user equipment. For instance, FIG. 4 shows a flowchart of a method for determining the BWP provided in an example of the present disclosure. The method is applied to the user equipment of the communication system shown in FIG. 1. The method includes the following steps.

Step 310, configuration information is received, where the configuration information is configured to configure at least one of a time domain resource indication or a frequency domain resource indication of the M time-frequency resources.

Before the BWP of the user equipment is determined, the configuration information sent by a network device is received by the user equipment. The configuration information includes the time domain resource indication and the frequency domain resource indication. The time domain resource indication is configured to indicate time domain resources of the M time-frequency resources. The frequency domain resource indication is configured to indicate frequency domain resources of the M time-frequency resources.

Alternatively, the time domain resource indication of the M time-frequency resources includes at least one of:
M time periods corresponding to the M time-frequency resources, where
each time-frequency resource corresponds to a respective time period, and the durations of the M time periods are identical; the time period may include at least one of a frame, a subframe, a slot, a symbol group, or a symbol; and for instance, as shown in FIG. 3, the network device configures 3 time periods of T1, T2 and T3 for a user equipment; or
time domain resource positions occupied by the M time-frequency resources in the M time periods.

For instance, the time domain resource positions occupied by each time-frequency resource in a corresponding time period are identical, and the time domain resource indication includes one group of time domain resource positions. For instance, as shown in FIG. 3, T1 corresponds to a first slot, T2 corresponds to a second slot, and T3 corresponds to a third slot. If the one group of time domain resource positions are configured to indicate fifth to eighth symbols in a slot, R1 occupies fifth to eighth symbols of a first slot in the time period T1, R2 occupies fifth to eighth symbols of a second slot in the time period T2, and R3 occupies fifth to eighth symbols of a third slot in the time period T3.

Alternatively, the time domain resource positions occupied by the M time-frequency resources in respective corresponding time periods are not identical, and the time domain resource indication includes a time domain resource position of each time-frequency resource. Alternatively, the time domain resource indication includes M groups of time domain resource positions. For instance, as shown in FIG. 3, T1 corresponds to a first slot, T2 corresponds to a second slot, and T3 corresponds to a third slot, which respectively indicate that R1 occupies second to fourth symbols of a first slot in the time period T1, R2 occupies third to fifth symbols of a second slot in the time period T2, and R3 occupies fourth to sixth symbols of a third slot in the time period T3.

Alternatively, the time domain resource indication of the M time-frequency resources includes at least one of:
a cycle period, where
one cycle period is configured to indicate one time period in which the M time-frequency resources are cycled once, and for instance, as shown in FIG. 5, T represents one cycle period;
a period number of the cycle period, where
for instance, as shown in FIG. 5, a period number K of the cycle period is 2;
a time period number M corresponding to the M time-frequency resources in each cycle period, where
a time period number M corresponding to each cycle period is configured to indicate that time in the cycle period is equally divided into the M time periods, for instance, as shown in FIG. 5, M is 3, and the cycle period is divided into 3 time periods: T1, T2, and T3; or
time domain resource positions occupied by the M time-frequency resources in M time periods, where
for instance, the time domain resource positions occupied by each time-frequency resource in a corresponding time period are identical, and the time domain resource indication includes one group of time domain resource positions. Alternatively, the time domain resource positions occupied by the M time-frequency resources in respective corresponding time periods are not identical, and the time domain resource indication includes a time domain resource position of each time-frequency resource. Alternatively, the time domain resource indication includes M groups of time domain resource positions.

Information included in the time domain resource indication indicates a time domain resource used in one cycle period, and the time domain resource position indicated in the information is used in each cycle period.

Alternatively, the frequency domain resource indication of the M time-frequency resources includes:
M frequency domain resource positions corresponding to the M time-frequency resources. For instance, frequency domain resource positions of the M time-frequency resources are completely overlapped; or, frequency domain resource positions of the M time-frequency resources are partially overlapped.

From the above description, it may be seen that a configuration mode of the time domain resource indication of the M time-frequency resources may include two modes. Accordingly, the configuration information may include the following two combinations:
First, the configuration information may include:
M time periods corresponding to the M time-frequency resources;
time domain resource positions occupied by the M time-frequency resources in the M time periods; and
M frequency domain resource positions corresponding to the M time-frequency resources.
Second, the configuration information may include:
a cycle period;
a period number of the cycle period;
a time period number M corresponding to the M time-frequency resources in each cycle period; and
time domain resource positions occupied by the M time-frequency resources in the M time periods.

Step 320, the BWP of the user equipment is determined based on the configuration information.

For instance, the configuration information is configured to configure the BWP for the user equipment from the system bandwidth of the communication system. The communication system may be at least one of the LTE or NR systems.

Alternatively, the system bandwidth is less than 5 MHz. For instance, the system bandwidth is 3 MHz or 3.6 MHz.

Alternatively, the system bandwidth is less than 20 MHz. For instance, the system bandwidth is 5 MHz, 8 MHz, or 10 MHz.

The user equipment determines the BWP based on the configuration information. The BWP includes the frequency domain resources of the M time-frequency resources. The time domain resource positions of the M time-frequency resources correspond to at least two time periods. The durations of the at least two time periods are identical. In addition, the frequency domain resource positions of the M time-frequency resources are completely overlapped; or the frequency domain resource positions of the M time-frequency resources are partially overlapped.

The user equipment determines the frequency domain resources of the M time-frequency resources indicated in the configuration information, and the frequency domain resources of the M time-frequency resources are concatenated in the sequential order in the time domain, such that the BWP of the user equipment is obtained.

For instance, the frequency domain resource positions corresponding to the M time-frequency resources are located in the system bandwidth of the communication system. The system bandwidth includes a bandwidth less than 5 MHz; or the system bandwidth includes a bandwidth less than 20 MHz.

It should be noted that step 210 in the embodiment of FIG. 2 may be implemented through step 320, and the BWP of the user equipment may be obtained by concatenating the frequency domain resources of the M time-frequency resources.

In conclusion, according to the method for determining the BWP provided in the embodiment, the user equipment uses the frequency domain resources of the M time-frequency resources as its own BWP. In this way, a greater bandwidth may be obtained by scheduling frequency domain resources of a plurality of time-frequency resources. For instance, in a case that a bandwidth of a scheduling requirement between the user equipment and the network device is greater than the system bandwidth of the communication system, a bandwidth satisfying the scheduling requirement may be obtained by scheduling the frequency domain resources of the plurality of time-frequency resources as the BWP.

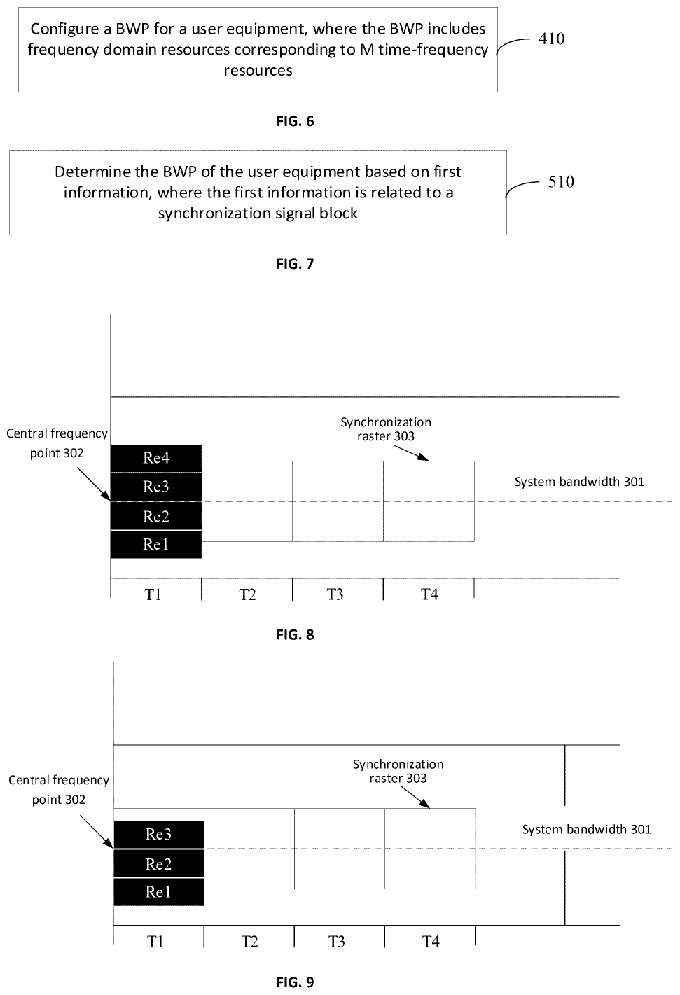

FIG. 6 shows a flowchart of a method for determining the BWP provided in an example of the present disclosure. The method is applied to the network device of the communication system shown in FIG. 1. The method includes the following step.

Step 410, a BWP is configured for a user equipment, where the BWP includes frequency domain resources of M time-frequency resources.

M is an integer greater than 1. The BWP includes the frequency domain resources of the M time-frequency resources. Alternatively, the BWP includes frequency domain bandwidths of the M time-frequency resources. Alternatively, the BWP includes the sum of the frequency domain resources of the M time-frequency resources. Alternatively, the BWP includes the sum of frequency domain bandwidths of the M time-frequency resources.

Alternatively, time domain resource positions of the M time-frequency resources correspond to at least two time periods.

For instance, time domain resources of the M time-frequency resources correspond to M time periods. In the M time-frequency resources, a time domain resource of each time-frequency resource is different from time domain resources of other (M−1) time-frequency resources. Alternatively, time domain resources of the M time-frequency resources correspond to M′ time periods. M′<M, and M′ is an integer greater than 1. In the M time-frequency resources, at least two time-frequency resources with identical time domain resources.

Alternatively, durations of the at least two time periods are identical.

Alternatively, frequency domain resource positions of the M time-frequency resources are completely overlapped; or, frequency domain resource positions of the M time-frequency resources are partially overlapped.

For instance, the M time-frequency resources are arranged in a sequential order in a time domain as the BWP of the user equipment. A high-frequency edge of an i-th time-frequency resource in the M time-frequency resources is connected to a low-frequency edge of an (i+1)-th time-frequency resource, and i is a positive integer less than M. For instance, a high-frequency edge of a first time-frequency resource is connected to a low-frequency edge of a second time-frequency resource, a high-frequency edge of the second time-frequency resource is connected to a low-frequency edge of a third time-frequency resource, and so on. A frequency domain resource obtained through connection is determined as the BWP of the user equipment.

Alternatively, the network device sends configuration information to the user equipment. The configuration information is configured to configure at least one of a time domain resource indication or a frequency domain resource indication of the M time-frequency resources for the user equipment.

Alternatively, the time domain resource indication of the M time-frequency resources includes at least one of:
M time periods corresponding to the M time-frequency resources; or
time domain resource positions occupied by the M time-frequency resources in the M time periods.

Alternatively, the time domain resource indication of the M time-frequency resources includes at least one of:
a cycle period;
a period number of the cycle period;
a time period number M corresponding to the M time-frequency resources in each cycle period; or
time domain resource positions occupied by the M time-frequency resources in the M time periods.

Alternatively, the frequency domain resource indication of the M time-frequency resources includes:
M frequency domain resource positions corresponding to the M time-frequency resources.

From the above description, it may be seen that the configuration information sent by the network device to the user equipment includes the following information:
M time periods corresponding to M time-frequency resources;
time domain resource positions occupied by the M time-frequency resources in the M time periods; and
M frequency domain resource positions corresponding to the M time-frequency resources.

Alternatively, the configuration information includes the following information:
a cycle period;
a period number of the cycle period;
a time period number M corresponding to the M time-frequency resources in each cycle period; and
time domain resource positions occupied by the M time-frequency resources in the M time periods.

For instance, the frequency domain resource positions corresponding to the configured M time-frequency resources are located in the system bandwidth of the communication system. The system bandwidth includes a bandwidth less than 5 MHz; or, the system bandwidth includes a bandwidth less than 20 MHz.

It should be noted that the embodiment shown in FIG. 6 is a method embodiment at a network device side corresponding to the embodiments shown in FIGS. 2 and 4, and a reception step at a terminal side and a transmission step at a network side may be combined into an interaction method between devices.

In conclusion, in a method for configuring the BWP provided in the embodiment, the network device configures the user equipment to use the sum of frequency domain bandwidths of the M time-frequency resources as the BWP, such that BWPs with different bandwidths may be flexibly configured for the user equipment. In a case that the system bandwidth fails to satisfy a scheduling requirement, the scheduling requirement with a greater bandwidth may be satisfied by concatenating frequency domain resources in different time domains.

FIG. 7 shows a flowchart of a method for determining the BWP provided in an example of the present disclosure. The method is applied to the user equipment of the communication system shown in FIG. 1. The method includes the following step.

Step 510, the BWP of the user equipment is determined based on first information, where the first information is related to a synchronization signal block.

According to a protocol, the user equipment determines the BWP used by the user equipment based on the first information. Alternatively, the first information includes at least one of:
a first raster, where
the first raster is a raster that receives the synchronization signal block, or, the first raster includes a first synchronization raster or a first channel raster;
a frequency band occupied by the synchronization signal block, i.e.
a frequency band occupied during transmission of the synchronization signal block; or
a frequency band occupied by a control resource set 0.

The control resource set 0 is indicated in information carried by the synchronization signal block. The user equipment may obtain the frequency band occupied by the control resource set 0 by parsing the synchronization signal block.

Alternatively, the user equipment determines the BWP of the user equipment based on the first raster.

For instance, the BWP of the user equipment may be determined based on the first raster through one of the following methods.

First, the user equipment determines N resource blocks at two sides of a central frequency point of the first raster, and a frequency band corresponding to the N resource blocks is determined as the BWP of the user equipment.

N is a positive integer. For instance, N is an even number. N/2 resource blocks are determined in a first frequency domain direction of the central frequency point, and N/2 resource blocks are determined in a second frequency domain direction of the central frequency point, such that the N resource blocks are obtained. The frequency band corresponding to the N resource blocks is determined as the BWP of the user equipment. As shown in FIG. 8, 2 groups of resource blocks of Re1 and Re2 are determined at one side of a central frequency point 302 of a synchronization raster 303, and 2 groups of resource blocks of Re3 and Re4 are determined at the other side of the central frequency point 302. A number of resource blocks in each group of resource blocks is identical, and each group of resource blocks includes at least one resource block.

Alternatively, N is an odd number and is represented as 2n+1, n resource blocks are determined in the first frequency domain direction of the central frequency point, and n+1 resource blocks are determined in the second frequency domain direction of the central frequency point, such that 2n+1 resource blocks are obtained. A frequency band corresponding to the 2n+1 resource blocks is determined as the BWP of the user equipment, and n is an integer greater than or equal to 0. As shown in FIG. 9, 2 groups of resource blocks of Re1 and Re2 are determined at one side of the central frequency point 302, and 1 group of resource block of Re3 is determined at the other side of the central frequency point 302.

The first frequency domain direction is opposite to the second frequency domain direction. For instance, the first frequency domain direction is a high frequency direction, and the second frequency domain direction is a low frequency direction. Alternatively, the first frequency domain direction is a low frequency direction, and the second frequency domain direction is a high frequency direction.

Second, the user equipment determines an offset central frequency point obtained after offsetting the first raster towards the first frequency domain direction by a first offset, N resource blocks at two sides of the offset central frequency point are determined, and a frequency band corresponding to the N resource blocks is determined as the BWP of the user equipment.

For instance, the first offset is defined by a protocol. Alternatively, the first offset is pre-configured for the user equipment by the network device. For instance, a value of the first offset may be defined as 50 kHz, 100 kHz, or 150 kHz.

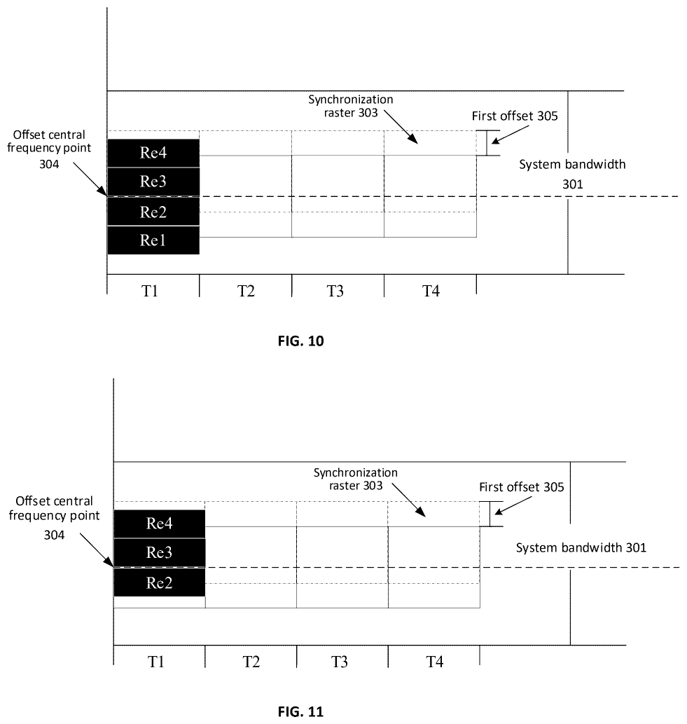

For instance, the first raster is offset towards the first frequency domain direction by the first offset. Alternatively, the central frequency point of the first raster is offset towards the first frequency domain direction by the first offset. The frequency band corresponding to the N resource blocks at the two sides of the offset central frequency point is determined as the BWP of the user equipment. For instance, the offset central frequency point is determined, and N is an even number. N/2 resource blocks are determined in a first frequency domain direction of the offset central frequency point, and N/2 resource blocks are determined in a second frequency domain direction of the offset central frequency point, such that the N resource blocks are obtained. The frequency band corresponding to the N resource blocks is determined as the BWP of the user equipment. As shown in FIG. 10, 2 groups of resource blocks of Re1 and Re2 are determined at one side of the offset central frequency point 304, and 2 groups of resource blocks of Re3 and Re4 are determined at the other side of the offset central frequency point 304. Additionally, the first offset 305 is shown in FIG. 10.

Alternatively, N is an odd number and is represented as 2n+1, n resource blocks are determined in the first frequency domain direction of the offset central frequency point, and n+1 resource blocks are determined in the second frequency domain direction of the offset central frequency point, such that 2n+1 resource blocks are obtained. A frequency band corresponding to the 2n+1 resource blocks is determined as the BWP of the user equipment. As shown in FIG. 11, 1 group of resource block of Re2 is determined at one side of the offset central frequency point 304, and 2 groups of resource blocks of Re3 and Re4 are determined at the other side of the offset central frequency point 304.

Alternatively, the user equipment determines the BWP of the user equipment based on the frequency band occupied by the synchronization signal block.

For instance, the user equipment may determine the BWP of the user equipment based on a first edge of the frequency band occupied by the synchronization signal block in the first frequency domain direction.

The user equipment may determine its used BWP based on the first edge through one of the following methods.

First, N resource blocks are determined in a second frequency domain direction by using the first edge as a start, and a frequency band corresponding to the N resource blocks is determined as the BWP of the user equipment.

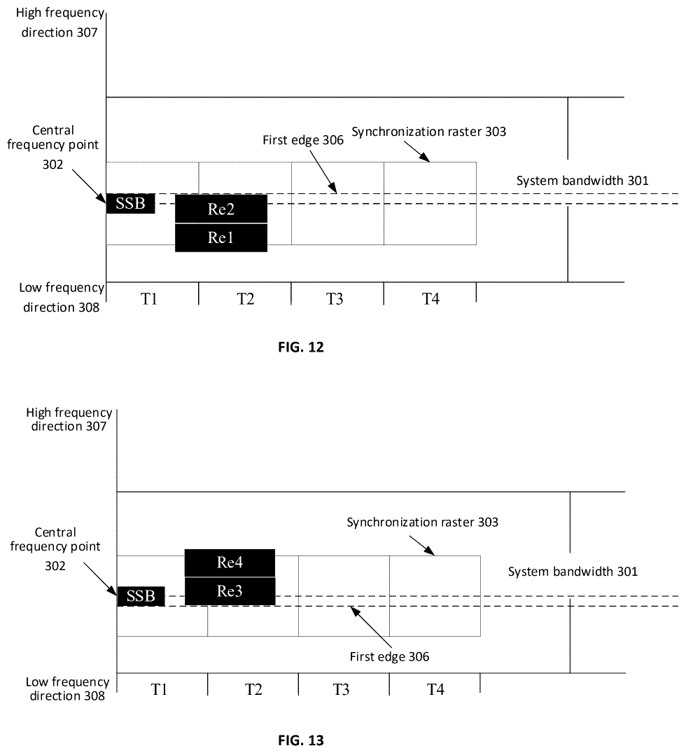

For instance, as shown in FIG. 12, a first edge 306 of a synchronization signal block in a high frequency direction 307 is determined as a start, two groups of resource blocks of Re1 and Re2 are determined in a low frequency direction 308, and a frequency band corresponding to the two groups of resource blocks is determined as the BWP of the user equipment. Alternatively, as shown in FIG. 13, a first edge 306 of a synchronization signal block in a low frequency direction 308 is determined as a start, two groups of resource blocks of Re3 and Re4 are determined in a high frequency direction 307, and a frequency band corresponding to the two groups of resource blocks is determined as the BWP of the user equipment.

Second, a frequency domain position obtained after offsetting the first edge towards the first frequency domain direction by a second offset is determined as a start, N resource blocks are determined in the second frequency domain direction, and the frequency band corresponding to the N resource blocks is determined as the BWP of the user equipment. The first frequency domain direction is opposite to the second frequency domain direction.

For instance, the second offset is defined by a protocol. Alternatively, the second offset is pre-configured for the user equipment by a network device. For instance, a value of the second offset may be defined as 50 kHz, 100 kHz, or 150 kHz.

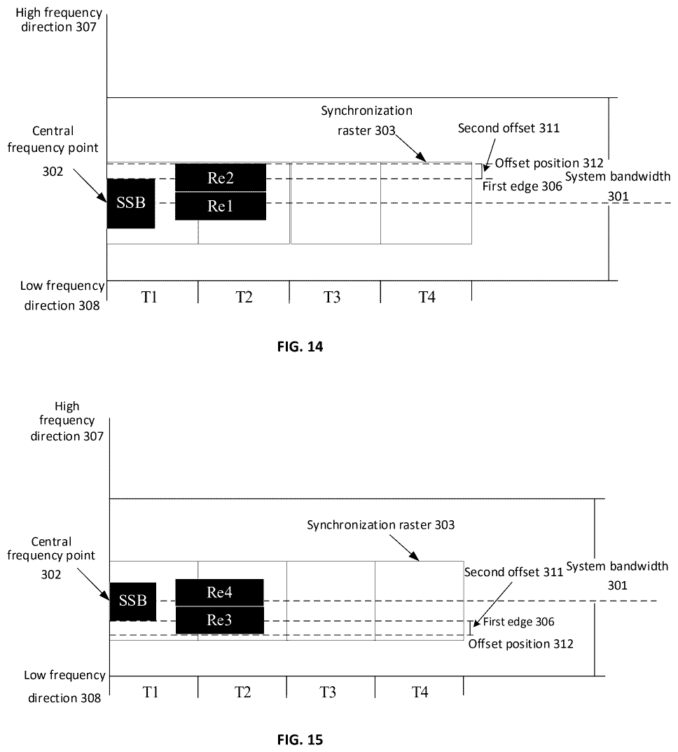

For instance, as shown in FIG. 14, an offset position 312 obtained after offsetting the first edge 306 of the synchronization signal block in a high frequency direction 307 towards the high frequency direction 307 by a second offset 311 is determined as a start, two groups of resource blocks of Re1 and Re2 are determined in a low frequency direction 308, and a frequency band corresponding to the two groups of resource blocks is determined as the BWP of the user equipment. Alternatively, as shown in FIG. 15, an offset position 312 obtained after offsetting the first edge 306 of the synchronization signal block in a low frequency direction 308 towards the low frequency direction 308 by a second offset 311 is determined as a start, two groups of resource blocks of Re3 and Re4 are determined in a high frequency direction 307, and a frequency band corresponding to the two groups of resource blocks is determined as the BWP of the user equipment.

For instance, the determined BWP used by the user equipment may be completely overlapped or partially overlapped with the frequency band occupied by the received synchronization signal block.

Alternatively, the user equipment determines the BWP of the user equipment based on the frequency band occupied by the control resource set 0.

For instance, the user equipment may determine the BWP of the user equipment based on a second edge of the frequency band occupied by the control resource set 0 in the first frequency domain direction.

The user equipment may determine its used BWP based on the second edge through one of the following methods.

First, N resource blocks are determined in a second frequency domain direction by using the second edge as a start, and a frequency band corresponding to the N resource blocks is determined as the BWP of the user equipment.

For instance, a second edge of the control resource set 0 in the high frequency direction is determined as a start, the N resource blocks are determined in the low frequency direction, and the frequency band corresponding to N frequency domain resource blocks is determined as the BWP of the user equipment. Alternatively, a second edge of the control resource set 0 in the low frequency direction is determined as a start, the N resource blocks are determined in the high frequency direction, and the frequency band corresponding to N frequency domain resource blocks is determined as the BWP of the user equipment.

Second, a frequency domain position obtained after offsetting the second edge towards the first frequency domain direction by a third offset is determined as a start, the N resource blocks are determined in the second frequency domain direction, and the frequency band corresponding to the N resource blocks is determined as the BWP of the user equipment.

For instance, the third offset is defined by a protocol. Alternatively, the third offset is pre-configured for the user equipment by a network device. For instance, a value of the third offset may be defined as 50 kHz, 100 kHz, or 150 kHz.

For instance, a frequency domain position obtained after offsetting the second edge of the control resource set 0 in a high frequency direction towards the high frequency direction by a third offset is determined as a start, the N resource blocks are determined in a low frequency direction, and a frequency band corresponding to the N resource blocks is determined as the BWP of the user equipment. Alternatively, a frequency domain position obtained after offsetting the second edge of the control resource set 0 in a low frequency direction towards the low frequency direction by a third offset is determined as a start, the N resource blocks are determined in a high frequency direction, and a frequency band corresponding to the N resource blocks is determined as the BWP of the user equipment.

For instance, the determined BWP used by the user equipment may be completely overlapped or partially overlapped with a frequency domain occupied by the control resource set 0.

Alternatively, the BWP of the user equipment includes the N resource blocks, and a value of N is less than or equal to 20. For instance, the value of N is defined by a protocol. Alternatively, the value of N is pre-configured for the user equipment by a network device. The value of N may be defined as 6, 8, or 10.

In conclusion, in the method for determining the BWP provided in the embodiment, the user equipment determines the BWP used by the user equipment based on information associated with the synchronization signal block, such that one effective BWP within the system bandwidth of the communication system is determined, and it is ensured that the scheduling of the network device does not exceed the system bandwidth.

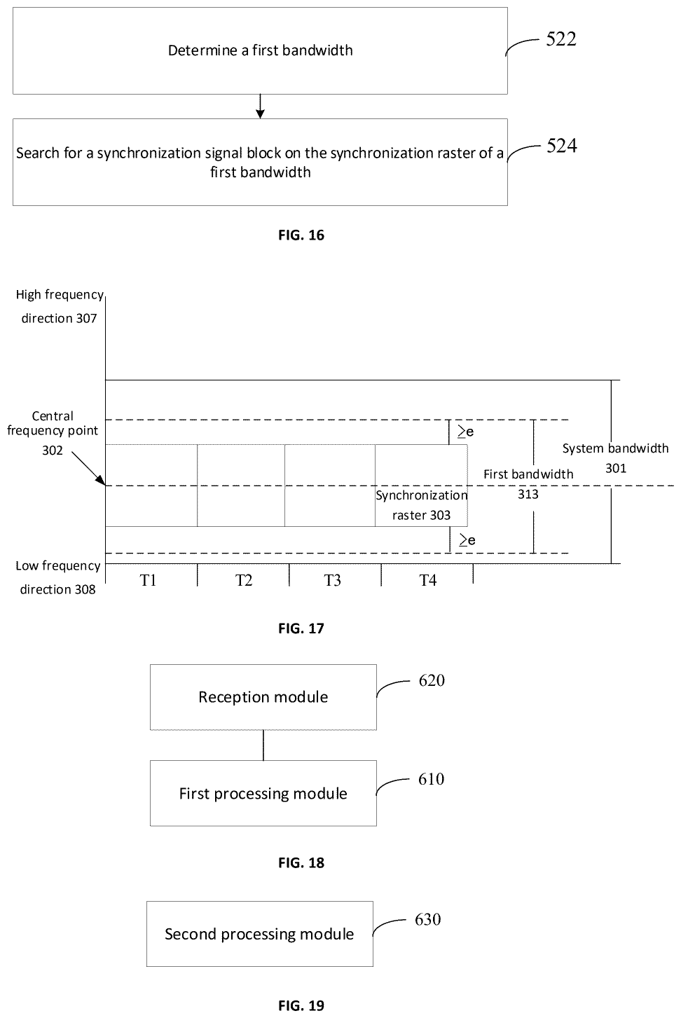

In some embodiments, before the BWP used by the user equipment is determined, the user equipment may search for the synchronization signal block in part of a bandwidth less than the system bandwidth. For instance, FIG. 16 shows a flowchart of a method for searching for a synchronization signal block provided in an example of the present disclosure. The method is applied to the user equipment of the communication system shown in FIG. 1. The method includes the following steps.

Step 522, a first bandwidth is determined.

For instance, the user equipment determines the first bandwidth that satisfies the following features:
a distance between a third edge and a fourth edge is greater than or equal to a distance threshold, where
the third edge is an edge of a raster at a start of a search in the first frequency domain direction, and the fourth edge is an edge of the first bandwidth in the first frequency domain direction; and
a distance between a fifth edge and a sixth edge is greater than or equal to the distance threshold, where
the fifth edge is an edge of the raster at an end of the search in the second frequency domain direction. The sixth edge is an edge of the first bandwidth in the second frequency domain direction.

Alternatively, the raster is a synchronization raster or a channel raster.

For instance, as shown in FIG. 17, a distance between a third edge of the synchronization raster 303 at the start of the search in a high frequency direction 307 and a fourth edge of the first bandwidth 313 in the high frequency direction 307 is greater than or equal to the distance threshold e. A distance between a fifth edge of a synchronization raster 303 at an end of the search in a low frequency direction 308 and a sixth edge of the first bandwidth 313 in the low frequency direction 308 is greater than or equal to the distance threshold e.

For instance, a frequency domain range where the first bandwidth 313 is located is included in a frequency domain range where a second bandwidth is located. The second bandwidth may be the system bandwidth 301 of the communication system. The first bandwidth 313 is less than the system bandwidth 301 of the communication system.

Alternatively, the system bandwidth is less than 5 MHz. For instance, the system bandwidth is 3 MHz or 3.6 MHz.

Alternatively, the system bandwidth is less than 20 MHz. For instance, the system bandwidth is 5 MHz, 8 MHz, or 10 MHz.

Step 524, a synchronization signal block is searched on the synchronization raster of the first bandwidth.

The user equipment searches for the synchronization signal block on the raster of the first bandwidth from the first frequency domain direction to the second frequency domain direction. For instance, from high frequency to low frequency, the synchronization signal block is searched on the synchronization raster of the first bandwidth; or, from low frequency to high frequency, the synchronization signal block is searched on the synchronization raster of the first bandwidth.

Alternatively, a value of the distance threshold is less than or equal to 800 KHz. For instance, the value of the distance threshold may be 4 RB, 700 kHz, 720 kHz, 750 kHz, or 800 kHz.

In conclusion, the method for searching for the synchronization signal block provided in the embodiment determines the first bandwidth based on the edge of the raster in the frequency domain, such that a bandwidth for frequency sweeping during the search for the synchronization signal block can be effectively reduced, and blind detection cannot be performed in a raster of a removed bandwidth part. Thus, a number of blind detections of the user equipment is reduced, and a power-saving effect during blind detection of the synchronization signal block is achieved.

From the above description, the solution of the embodiments of the present disclosure includes the following three points.
1) A joint bandwidth is defined, and is also referred to as a joint BWP, that is, the BWP of the user equipment in the embodiments shown in FIGS. 2, 4 and 6. A greater bandwidth is obtained by concatenating frequency domain resource domains in different time domains.
2) An effective BWP is defined, that is, the BWP of the user equipment in the embodiment shown in FIG. 7. An effective BWP within the system bandwidth is determined in an implicit way, to ensure that the scheduling of a base station does not exceed the system bandwidth.
3) The UE reduces the number of frequency sweeping by skipping part of frequency sweeping in a frequency band.

For point 1), in the embodiment of the present disclosure, a network device sends the SSB at a frequency domain position where at least one synchronization raster of the system bandwidth is located, that is, a central frequency point of the SSB is aligned with a synchronization raster. The UE determines the synchronization raster sent by the SSB through blind detection, and further receives and decodes the SSB, to complete initial access. The UE obtains a CORESET0 configuration according to decoded master information block (MIB) information, and the MIB information is carried by the SSB. The system bandwidth is less than 5 MHz. Preferably, the system bandwidth is 3 MHz or 3.6 MHz. After the UE accesses a network, the network device configures the joint BWP for the UE, and the network device and the UE perform data interaction in the joint bandwidth.

In the embodiment, the network device sends the SSB at the frequency domain position where the at least one synchronization raster of the system bandwidth is located, that is, the central frequency point of the SSB is aligned with the synchronization raster. The UE determines the synchronization raster sent by the SSB through blind detection, and further receives and decodes the SSB, to complete initial access. The UE obtains the CORESET0 configuration according to the decoded MIB information, and the MIB information is carried by the SSB. The system bandwidth is less than 20 MHz. Preferably, the system bandwidth is 5 MHz, 8 MHz, or 10 MHz. After the UE accesses the network, the network device configures the joint BWP for the UE, and the network device and the UE perform data interaction in the effective bandwidth.

Features of the joint bandwidth of frequency domain concatenation include at least one of:
joint bandwidth resources span at least two time periods in a time domain; or
time periods for concatenating frequency domain resources are identical.

### Method 1

M time periods are configured, a length of each time period is identical, and M is an integer greater than 1.

Time domain resources corresponding to the time periods are configured. That is, the time domain resources occupied by the M time periods are configured.

M frequency domain resources corresponding to the M time periods are configured. The M frequency domain resources may be overlapped with each other.

The M frequency domain resources are sequentially concatenated in a time order. That is, a low-frequency edge of a second frequency domain resource is connected to a high-frequency edge of a first frequency domain resource domain, a low-frequency edge of a third frequency domain resource domain is connected to a high-frequency edge of a second frequency domain resource domain, and so on. A low-frequency edge of an M-th frequency domain resource domain is connected to a high-frequency edge of an (M−1)-th frequency domain resource domain.

### Method 2

A cycle period is configured.

A number K of cycles (that is, a period number of the cycle period) is configured. K is an integer greater than 1.

A time period number M in each cycle period is configured. M is an integer greater than 1.

Time domain resources corresponding to the time periods are configured. That is, the time domain resources occupied by the M time periods are configured.

M frequency domain resources corresponding to the M time periods are configured. The M frequency domain resources may be overlapped with each other.

The frequency domain resources in the cycle period are concatenated once in a time order. That is, a low-frequency edge of a second frequency domain resource is connected to a high-frequency edge of a first frequency domain resource, a low-frequency edge of a third frequency domain resource is connected to a high-frequency edge of the second frequency domain resource, and so on. A low-frequency edge of an M-th frequency domain resource is connected to a high-frequency edge of an (M−1)-th frequency domain resource.

In conclusion, through a method for configuring the joint BWP, frequency domain resource information of downlink data transmission may be obtained in a case of a limited bandwidth, and scheduling errors caused by an irrational initial BWP configuration may be avoided.

For point 2), in the embodiment of the present disclosure, a network device sends an SSB at a frequency domain position where at least one synchronization raster of the system bandwidth is located, that is, a central frequency point of the SSB is aligned with a synchronization raster. The UE determines the synchronization raster sent by the SSB through blind detection, and further receives and decodes the SSB, to complete initial access. The UE obtains the CORESET0 configuration according to the decoded MIB information, and the MIB information is carried by the SSB. The system bandwidth is less than 5 MHz. Preferably, the system bandwidth is 3 MHz or 3.6 MHz. After the UE accesses a network, the network device configures an effective BWP for the UE, and the network device and the UE perform data interaction in the effective bandwidth.

In the embodiment, the network device sends the SSB at the frequency domain position where the at least one synchronization raster of the system bandwidth is located, that is, the central frequency point of the SSB is aligned with the synchronization raster. The UE determines the synchronization raster sent by the SSB through blind detection, and further receives and decodes the SSB, to complete initial access. The UE obtains the CORESET0 configuration according to the decoded MIB information, and the MIB information is carried by the SSB. The system bandwidth is less than 20 MHz. Preferably, the system bandwidth is 5 MHz, 8 MHz, or 10 MHz. After the UE accesses a network, the network device configures an effective BWP for the UE, and the network device and the UE perform data interaction in the effective bandwidth.

A method for configuring the effective BWP includes at least one of the following methods.

### Method 1

Determining is performed in an implicit way. A synchronization raster of an SSB received by UE is determined as a reference. An effective BWP is configured by default.

For instance, the synchronization raster of the SSB received by the UE is determined as a central frequency point, and N RBs at two sides of the central frequency point are the effective BWP by default. N is preferably 6, 8, or 10.

For instance, reference is made to the synchronization raster of the SSB received by the UE, offsetting is performed by a first offset d1, a frequency point where the synchronization raster is offset by d1 is the central frequency point by default, and N RBs at two sides of the central frequency point are the effective BWP by default, where d1 is preferably 50 kHz, 100 kHz, or 150 kHz. N is preferably 6, 8, or 10.

### Method 2

Determining is performed in an implicit way. A low frequency direction edge or a high frequency direction edge of an SSB received by UE is determined as a reference. An effective BWP is configured by default.

For instance, the low frequency direction edge of the SSB received by the UE is determined as a reference, and N RBs of an edge in a high frequency direction are the effective BWP by default. N is preferably 16 or 20.

For instance, the high frequency direction edge of the SSB received by the UE is determined as a reference, and N RBs of an edge in a low frequency direction are the effective BWP by default. N is preferably 16 or 20.

For instance, the low frequency direction edge of the SSB received by the UE is determined as a reference, offsetting is performed by a second offset d2, and N RBs at an offset position in the high frequency direction are the effective BWP by default, where d2 is preferably 50 kHz, 100 kHz, or 150 kHz. N is preferably 16 or 20.

For instance, the high frequency direction edge of the SSB received by the UE is determined as a reference, offsetting is performed by a second offset d2, and N RBs at an offset position in the low frequency direction are the effective BWP by default, where d2 is preferably 50 kHz, 100 kHz, or 150 kHz. N is preferably 16 or 20.

### Method 3

Determining is performed in an implicit way. A low frequency direction edge or a high frequency direction edge of CORESET0 is determined as a reference. An effective BWP is configured by default.

For instance, the low frequency direction edge of the CORESET0 is determined as a reference, and N RBs of an edge in a high frequency direction are the effective BWP by default. N is preferably 16 or 20.

For instance, the high frequency direction edge of the CORESET0 is determined as a reference, and N RBs of an edge in a low frequency direction are the effective BWP by default. N is preferably 16 or 20.

For instance, the low frequency direction edge of the CORESET0 is determined as a reference, offsetting is performed by a third offset d3, and N RBs at an offset position in the high frequency direction are the effective BWP by default, where d3 is preferably 50 kHz, 100 kHz, or 150 kHz. N is preferably 16 or 20.

For instance, the high frequency direction edge of the CORESET0 is determined as a reference, offsetting is performed by a third offset d3, and N RBs at an offset position in the low frequency direction are the effective BWP by default, where d3 is preferably 50 kHz, 100 kHz, or 150 kHz. N is preferably 16 or 20.

In conclusion, through the method for configuring the effective BWP, frequency domain resource information of downlink data transmission may be obtained in a case of a limited bandwidth, and scheduling errors caused by an irrational initial BWP configuration may be avoided.

For point 3), in the embodiment of the present disclosure, a network device sends the SSB at a frequency domain position where at least one synchronization raster of the system bandwidth is located, that is, a central frequency point of the SSB is aligned with a synchronization raster. The UE determines the synchronization raster sent by the SSB through blind detection, and further receives and decodes the SSB, to complete initial access. The system bandwidth is configured in a first band, and is a continuous frequency domain resource.

A method for searching for the SSB by the UE includes at least one of the following methods.

### Method 1

UE performs the search from a low frequency direction of a first band to a high frequency direction.

A distance between a synchronization raster or channel raster at a start of the search and a low frequency direction edge of the first band is at least e.

A distance between a synchronization raster or channel raster at an end of the search and a high frequency direction edge of the first band is at least e.

Specifically, e is preferably 4 RB, 700 kHz, 720 kHz, 750 kHz, or 800 kHz.

### Method 2

UE performs the search from a high frequency direction of a first band to a low frequency direction.

A distance between a synchronization raster or channel raster at a start of the search and a low frequency direction edge of the first band is at least e.

A distance between a synchronization raster or channel raster at an end of the search and a high frequency direction edge of the first band is at least e.

Specifically, e is preferably 4 RB, 700 kHz, 720 kHz, 750 kHz, or 800 kHz.

In conclusion, a rational blind detection bandwidth is determined, such that a number of blind detections of the UE is reduced, and the purpose of power saving is achieved.

FIG. 18 shows a block diagram of a device for determining the BWP provided in an example of the present disclosure. The device may be implemented as part of UE or entire UE through software, hardware or a combination of both. The device includes:
a first processing module 610, configured to determine a BWP of a user equipment. The BWP includes frequency domain resources of M time-frequency resources. M is an integer greater than 1.

In some embodiments, time domain resource positions of the M time-frequency resources correspond to at least two time periods.

In some embodiments, durations of the at least two time periods are identical.

In some embodiments, frequency domain resource positions of the M time-frequency resources are completely overlapped; or,

The frequency domain resource positions of the M time-frequency resources are partially overlapped.

In some embodiments, a high-frequency edge of an i-th time-frequency resource in the M time-frequency resources is connected to a low-frequency edge of an (i+1)-th time-frequency resource.

The M time-frequency resources are arranged in a sequential order in a time domain, and i is an integer less than M.

In some embodiments, the device further includes:
a reception module 620, configured to receive configuration information, where the configuration information is configured to configure at least one of a time domain resource indication or a frequency domain resource indication of the M time-frequency resources; and
a first processing module 610 configured to determine the BWP of the user equipment based on the configuration information.

In some embodiments, the time domain resource indication of the M time-frequency resources includes at least one piece of:
M time periods corresponding to the M time-frequency resources; or
time domain resource positions occupied by the M time-frequency resources in the M time periods.

In some embodiments, the time domain resource indication of the M time-frequency resources includes at least one of:
a cycle period;
a period number of the cycle period;
a time period number M corresponding to the M time-frequency resources in each cycle period; or
time domain resource positions occupied by the M time-frequency resources in the M time periods.

In some embodiments, the frequency domain resource indication of the M time-frequency resources includes:
M frequency domain resource positions corresponding to the M time-frequency resources.

In some embodiments, frequency domain resource positions corresponding to the M time-frequency resources are located in a system bandwidth of a communication system. The system bandwidth includes a bandwidth less than 5 MHz.

FIG. 19 shows a block diagram of a device for determining the BWP provided in an example of the present disclosure. The device may be implemented as part of UE or entire UE through software, hardware or a combination of both. The device includes:
a second processing module 630, configured to determine a BWP of user equipment based on first information. The first information is related to a synchronization signal block.

In some embodiments, the first information includes at least one of:
a first synchronization raster, where the first synchronization raster is a raster that receives the synchronization signal block;
a frequency band occupied by the synchronization signal block; or
a frequency band occupied by a control resource set 0, where the control resource set 0 is indicated in information carried by the synchronization signal block.

In some embodiments, the second processing module 630 is configured to determine the BWP of the user equipment based on the first synchronization raster.

In some embodiments, the second processing module 630 is configured to:
determine N resource blocks at two sides of a central frequency point of the first synchronization raster, and determine a frequency band corresponding to the N resource blocks as the BWP of the user equipment; or,
determine an offset central frequency point obtained after offsetting the first synchronization raster towards a first frequency domain direction by a first offset; and determine N resource blocks at two sides of the offset central frequency point, and determine the frequency band corresponding to the N resource blocks as the BWP of the user equipment, where N is a positive integer.

In some embodiments, the second processing module 630 is configured to determine the BWP of the user equipment based on the frequency band occupied by the synchronization signal block.

In some embodiments, the second processing module 630 is configured to determine the BWP of the user equipment based on a first edge of the frequency band occupied by the synchronization signal block in a first frequency domain direction.

In some embodiments, the second processing module 630 is configured to:
determine N resource blocks in a second frequency domain direction by using the first edge as a start, and determine a frequency band corresponding to the N resource blocks as the BWP of the user equipment; or,
determine the N resource blocks in a second frequency domain direction by using a frequency domain position obtained after offsetting the first edge towards the first frequency domain direction by a second offset as a start, and determine the frequency band corresponding to the N resource blocks as the BWP of the user equipment.

The first frequency domain direction is opposite to the second frequency domain direction, and N is a positive integer.

In some embodiments, the second processing module 630 is configured to determine the BWP of the user equipment based on the frequency band occupied by the control resource set 0.

In some embodiments, the second processing module 630 is configured to determine the BWP of the user equipment based on a second edge of the frequency band occupied by the control resource set 0 in a first frequency domain direction.

In some embodiments, the second processing module 630 is configured to:
determine N resource blocks in a second frequency domain direction by using the second edge as a start, and determine a frequency band corresponding to the N resource blocks as the BWP of the user equipment; or,
determine the N resource blocks in the second frequency domain direction by using a frequency domain position obtained after offsetting the second edge towards the first frequency domain direction by a third offset as a start, and determine the frequency band corresponding to the N resource blocks as the BWP of the user equipment.

The first frequency domain direction is opposite to the second frequency domain direction, and N is a positive integer.

In some embodiments, the BWP of the user equipment includes N resource blocks, and a value of N is less than or equal to 20.

In some embodiments, the second processing module 630 is configured to:
determine a first bandwidth before the BWP of the user equipment is determined based on the first information; and
search for the synchronization signal block on a synchronization raster of the first bandwidth.

In some embodiments, the second processing module 630 is configured to:
search for the synchronization signal block on the synchronization raster of the first bandwidth from the first frequency domain direction to the second frequency domain direction.

The first frequency domain direction is opposite to the second frequency domain direction.

In some embodiments, features of the first bandwidth include the following:
a distance between a third edge and a fourth edge is greater than or equal to a distance threshold; and
a distance between a fifth edge and a sixth edge is greater than or equal to the distance threshold, where
the third edge is an edge of the synchronization raster at a start of a search in the first frequency domain direction, and the fourth edge is an edge of the first bandwidth in the first frequency domain direction; and the fifth edge is an edge of the synchronization raster at an end of the search in the second frequency domain direction, and the sixth edge is an edge of the first bandwidth in the second frequency domain direction.

In some embodiments, a value of the distance threshold is less than or equal to 800 KHz.

In some embodiments, the first bandwidth is less than a system bandwidth of a communication system. The system bandwidth includes a bandwidth less than 5 MHz.

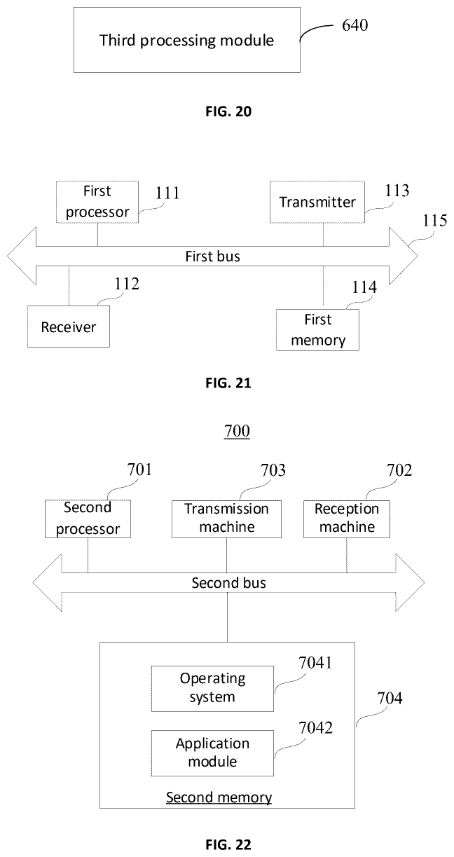

FIG. 20 shows a block diagram of a device for determining the BWP provided in an example of the present disclosure. The device may be implemented as part of a network device or an entire network device through software, hardware or a combination of both. The device includes:
a third processing module 640, configured to configure the BWP for user equipment. The BWP includes frequency domain resources of M time-frequency resources. M is an integer greater than 1.

In some embodiments, time domain resource positions of the M time-frequency resources correspond to at least two time periods.

In some embodiments, durations of the at least two time periods are identical.

In some embodiments, frequency domain resource positions of the M time-frequency resources are completely overlapped; or,
the frequency domain resource positions of the M time-frequency resources are partially overlapped.

In some embodiments, a high-frequency edge of an i-th time-frequency resource in the M time-frequency resources is connected to a low-frequency edge of an (i+1)-th time-frequency resource.

The M time-frequency resources are arranged in a sequential order in a time domain, and i is an integer less than M.

In some embodiments, the third processing module 640 is configured to send configuration information to the user equipment. The configuration information is configured to configure at least one of a time domain resource indication or a frequency domain resource indication of the M time-frequency resources for the user equipment.

In some embodiments, the time domain resource indication of the M time-frequency resources includes at least one of:
M time periods corresponding to the M time-frequency resources; or
time domain resource positions occupied by the M time-frequency resources in the M time periods.

In some embodiments, the time domain resource indication of the M time-frequency resources includes at least one of:
a cycle period;
a period number of the cycle period;
a time period number M corresponding to the M time-frequency resources in each cycle period; or
time domain resource positions occupied by the M time-frequency resources in the M time periods.

In some embodiments, the frequency domain resource indication of the M time-frequency resources includes:
M frequency domain resource positions corresponding to the M time-frequency resources.

In some embodiments, frequency domain resource positions corresponding to the M time-frequency resources are located in a system bandwidth of a communication system. The system bandwidth includes a bandwidth less than 5 MHz.

FIG. 21 is a schematic structural diagram of a UE provided in an example of the present disclosure. The UE includes: a first processor 111, a receiver 112, a transmitter 113, a first memory 114, and a first bus 115.

The first processor 111 includes one or more processing cores. The first processor 111 executes various functional applications and information processing by running a software program and a module.

The receiver 112 and the transmitter 113 may be implemented as a communication component. The communication component may be a communication chip.

The first memory 114 is connected to the first processor 111 through the first bus 115.

The first memory 114 may be configured to store at least one instruction. The first processor 111 is configured to implement all the steps in the above method embodiment by executing the at least one instruction.

In addition, the first memory 114 may be implemented by any type of volatile or nonvolatile storage device or a combination of them. The volatile or nonvolatile storage device includes, but is not limited to, a magnetic disk or an optical disk, an electrically erasable programmable read only memory (EEPROM), an erasable programmable read only memory (EPROM), a static random-access memory (SRAM), a read only memory (ROM), a magnetic memory, a flash memory, and a programmable read only memory (PROM).

An example further provides a non-transitory computer-readable storage medium including instructions, such as a memory including instructions. The instructions may be executed by a processor of UE, such that the method for determining a bandwidth part is completed. For instance, the non-transitory computer-readable storage medium may be an ROM, a random-access memory (RAM), a compact disc read only memory (CD-ROM), a magnetic tape, a floppy disk, an optical data storage device, etc.

According to the non-transitory computer-readable storage medium, when the instructions in the non-transitory computer-readable storage medium are executed by the processor of the UE, the UE is caused to perform the method for determining the BWP.

FIG. 22 is a block diagram of an access network device 700 according to an example. The access network device 700 may be a base station.

The access network device 700 may include: a second processor 701, a reception machine 702, a transmission machine 703, and a second memory 704. The reception machine 702, the transmission machine 703 and the second memory 704 are connected to the second processor 701 separately through a second bus 705.

The second processor 701 includes one or more processing cores. The second processor 701 performs the method performed by the access network device in the method for determining the BWP provided in the embodiment of the present disclosure by running a software program and a module. The second memory 704 may be configured to store the software program and module. Specifically, the second memory 704 may store an operating system 7041, and an application module 7042 required for at least one function. The reception machine 702 is configured to receive communication data sent by other devices. The transmission machine 703 is configured to transmit communication data to other devices.

An example of the present disclosure further provides a computer-readable storage medium. The computer-readable storage medium stores at least one instruction, at least one program, a code set, or an instruction set. The at least one instruction, the at least one program, and the code set or the instruction set are loaded and executed by a processor, such that the method for determining the BWP provided in all the method embodiments is implemented.

An example of the present disclosure further provides a computer program product. The computer program product includes computer instructions. The computer instructions are stored in a computer-readable storage medium. A processor of a computer device reads the computer instructions from the computer-readable storage medium. The processor executes the computer instructions, such that the computer device is caused to perform the method for determining a BWP according to all the method embodiments.

It should be understood that as used here, “a plurality of” means two or more. When describing an association relation of associated objects, “and/or” means that there may be three relations. For instance, A and/or B may mean that A exists alone, both A and B exist, or B exists alone. The character “/” generally indicates an “or” relation between two associated context objects.

Those skilled in the art could easily conceive of other implementation solutions of the present disclosure upon consideration of the description and the invention disclosed here. The present disclosure is intended to cover any variations, uses or adaptive changes of the present disclosure, which follow the general principles of the present disclosure and include common general knowledge or conventional technical means in the technical field that is not disclosed in the present disclosure. The description and the embodiments are regarded as merely illustrative, and the true scope and spirit of the present disclosure are indicated in the following claims.

It should be understood that the present disclosure is not limited to a precise structure described above and illustrated in the accompanying drawings, and can modified and changed in various ways without departing from the scope. The scope of the present disclosure is limited merely by the appended claims.

1. A method for determining a bandwidth part (BWP), performed by a user equipment, comprising:
determining the BWP of the user equipment, wherein the BWP comprises frequency domain resources of M time-frequency resources, wherein M is an integer greater than 1.

2. The method according to claim 1, wherein time domain resource positions of the M time-frequency resources correspond to at least two time periods.

3. The method according to claim 2, wherein durations of the at least two time periods are identical.

4. The method according to claim 1, wherein
frequency domain resource positions of the M time-frequency resources are completely overlapped; or,
the frequency domain resource positions of the M time-frequency resources are partially overlapped.

5. The method according to claim 1, wherein a high-frequency edge of an i-th time-frequency resource in the M time-frequency resources is connected to a low-frequency edge of an (i+1)-th time-frequency resource; and
the M time-frequency resources are arranged in a sequential order in a time domain, and i is an integer less than M.

6. The method according to claim 1, further comprising:
receiving configuration information, wherein the configuration information is configured to configure at least one of a time domain resource indication or a frequency domain resource indication of the M time-frequency resources; and
determining the BWP of the user equipment comprises:
determining the BWP of the user equipment based on the configuration information.

7. The method according to claim 6, wherein the time domain resource indication of the M time-frequency resources comprises at least one of:
M time periods corresponding to the M time-frequency resources;
time domain resource positions occupied by the M time-frequency resources in the M time periods; or
wherein the time domain resource indication of the M time-frequency resources comprises at least one of:
a cycle period;
a period number of the cycle period;
a time period number M corresponding to the M time-frequency resources in each cycle period; or
time domain resource positions occupied by the M time-frequency resources in M time periods.

8. (canceled)

9. The method according to claim 6, wherein the frequency domain resource indication of the M time-frequency resources comprises:
M frequency domain resource positions corresponding to the M time-frequency resources.

10. The method according to claim 1, wherein frequency domain resource positions corresponding to the M time-frequency resources are located in a system bandwidth of a communication system, and the system bandwidth comprises a bandwidth less than 5 MHz.

11. A method for determining a bandwidth part (BWP), performed by a user equipment, comprising:
determining a BWP of the user equipment based on first information, wherein the first information is related to a synchronization signal block.

12. The method according to claim 11, wherein the first information comprises at least one of:
a first synchronization raster, wherein the first synchronization raster is a raster that receives the synchronization signal block;
a frequency band occupied by the synchronization signal block; or
a frequency band occupied by a control resource set 0, wherein the control resource set 0 is indicated in information carried by the synchronization signal block.

13. The method according to claim 12, wherein determining the BWP of the user equipment based on first information comprises:
determining the BWP of the user equipment based on the first synchronization raster;
determining the BWP of the user equipment based on the frequency band occupied by the synchronization signal block; or
determining the BWP of the user equipment based on the frequency band occupied by the control resource set 0.

14. The method according to claim 13, wherein determining the BWP of the user equipment based on the first synchronization raster comprises:
determining N resource blocks at two sides of a central frequency point of the first synchronization raster, and determining a frequency band corresponding to the N resource blocks as the BWP of the user equipment; or,
determining an offset central frequency point after offsetting the first synchronization raster towards a first frequency domain direction by a first offset; and determining N resource blocks at two sides of the offset central frequency point, and determining the frequency band corresponding to the N resource blocks as the BWP of the user equipment, wherein N is a positive integer; or
wherein determining the BWP of the user equipment based on the frequency band occupied by the synchronization signal block comprises:
determining the BWP of the user equipment based on a first edge of the frequency band occupied by the synchronization signal block in a first frequency domain direction; or
wherein determining the BWP of the user equipment based on the frequency band occupied by the control resource set 0 comprises:
determining the BWP of the user equipment based on a second edge of the frequency band occupied by the control resource set 0 in a first frequency domain direction.

15-16. (canceled)

17. The method according to claim 14, wherein determining the BWP of the user equipment based on the first edge of the frequency band occupied by the synchronization signal block in the first frequency domain direction comprises:
determining N resource blocks in a second frequency domain direction by using the first edge as a start, and determining a frequency band corresponding to the N resource blocks as the BWP of the user equipment; or
determining the N resource blocks in the second frequency domain direction by using a frequency domain position obtained after offsetting the first edge towards the first frequency domain direction by a second offset as the start, and determining the frequency band corresponding to the N resource blocks as the BWP of the user equipment;
wherein the first frequency domain direction is opposite to the second frequency domain direction, and N is a positive integer.

18-19. (canceled)

20. The method according to claim 14, wherein determining the BWP of the user equipment based on the second edge of the frequency band occupied by the control resource set 0 in the first frequency domain direction comprises:
determining N resource blocks in a second frequency domain direction by using the second edge as a start, and determining a frequency band corresponding to the N resource blocks as the BWP of the user equipment; or,
determining the N resource blocks in the second frequency domain direction by using a frequency domain position obtained after offsetting the second edge towards the first frequency domain direction by a third offset as a start, and determining the frequency band corresponding to the N resource blocks as the BWP of the user equipment;
wherein the first frequency domain direction is opposite to the second frequency domain direction, and N is a positive integer.

21. (canceled)

22. The method according to claim 11, wherein before determining the BWP of the user equipment
determining a first bandwidth; and
searching for the synchronization signal block on a synchronization raster of the first bandwidth.

23. The method according to claim 22, wherein searching for the synchronization signal block on the synchronization raster of the first bandwidth comprises:
searching for the synchronization signal block on the synchronization raster of the first bandwidth from first frequency domain direction to second frequency domain direction, wherein
the first frequency domain direction is opposite to the second frequency domain direction.

24. The method according to claim 23, wherein features of the first bandwidth comprise:
a distance between a third edge and a fourth edge is greater than or equal to a distance threshold; and
a distance between a fifth edge and a sixth edge is greater than or equal to the distance threshold, wherein
the third edge is an edge of the synchronization raster at a start of a search in the first frequency domain direction, and the fourth edge is an edge of the first bandwidth in the first frequency domain direction; and the fifth edge is an edge of the synchronization raster at an end of the search in the second frequency domain direction, and the sixth edge is an edge of the first bandwidth in the second frequency domain direction.

25-26. (canceled)

27. A method for configuring a bandwidth part (BWP), performed by a network device, comprising:
configuring the BWP for a user equipment, wherein the BWP comprises frequency domain resources of M time-frequency resources, wherein M is an integer greater than 1.

28-31. (canceled)

32. The method according to claim 27, wherein configuring the BWP for the user equipment comprises:
sending configuration information to the user equipment, wherein the configuration information is configured to configure at least one of a time domain resource indication or a frequency domain resource indication of the M time-frequency resources for the user equipment.

33-44. (canceled)
